(19) United States
(12) Patent Application Publication
(10) Pub. No.: US 2012/0312560 A1
(43) Pub. Date: Dec. 13, 2012

(54) SEALING APPARATUS AND METHOD FOR FORMING A SEAL IN A SUBTERRANEAN WELLBORE

(75) Inventors: Jeffrey L. Bahr, The Woodlands, TX (US); S. Gina Butuc, The Woodlands, TX (US); Manuel Quevedo-Lopez, Richardson, TX (US)

(73) Assignees: Board of Regents, The University of Texas System, Austin, TX (US); Nanocomposites Inc., The Woodlands, TX (US)

(21) Appl. No.: 13/489,093

(22) Filed: Jun. 5, 2012

Related U.S. Application Data
(60) Provisional application No. 61/615,392, filed on Mar. 26, 2012.
(60) Provisional application No. 61/546,767, filed on Oct. 13, 2011.
(60) Provisional application No. 61/494,378, filed on Jun. 7, 2011.

(51) Int. Cl. E21B 33/12; E21B 43/00; B82Y 99/00

(52) U.S. Cl. 166/387; 166/118; 166/66; 977/700

(57) ABSTRACT

Disclosed are apparatuses useful for forming a seal in a subterranean wellbore and methods for using the disclosed apparatuses for forming a seal in a wellbore. The apparatus is a part of a system that provides a wellbore seal that is capable of communicating the status of the applied seal to the user

### PRIORITY

This application claims priority to U.S. Provisional Application 61/494,378, filed Jun. 7, 2011, to U.S. Provisional Application 61/546,767, filed Oct. 13, 2011, and to U.S. Provisional Application 61/615,392, filed Mar. 26, 2012, all of which are incorporated herein in their entirety.

### FIELD

Disclosed are apparatuses useful for forming a seal in a subterranean wellbore and methods for using the disclosed apparatuses for forming a seal in a wellbore. The apparatus is a part of a system that provides a wellbore seal that is capable of communicating the status of the applied seal to the user.

### BACKGROUND

Wells have been drilled since antiquity to extract water from subterranean sources for private or commercial use. In more recent times wells have been used to recover subterranean sources of hydrocarbons, for example, crude petroleum and natural gas; and in some instances an inert gas such helium.

Typically after a hole has been bored into the ground and in some instances a casing is inserted which provides a stable outside surface referred to as a wellbore. Into the wellbore is inserted a conduit which can further comprise other conduits or devices necessary for working the recovery of the material being extracted. This conduit is sometimes referred to as a mandrel by the artisan.

In current operations, a packer is circumferentially deposed along the outer surface of the conduit and contains an expandable sealing device. When activated the sealing device divides the annulus created when the packer-containing conduit is first inserted into the wellbore prior to activation. Activation of the seal creates a cavity below the packer.

Current packers can be activated by various means, for example, by applying a force to the top of the packer causing expansion of the seal or by addition of a fluid which causes the seal to expand against the inner wall of the wellbore casing. The user of these methods for sealing a wellbore, however, has no way of knowing whether the seal is completely engaged. For example, whether the seal has uniformly expanded or whether the seal is against the inner wall of the casing with equal pressure or force along the whole circumference of the seal.

Therefore, there is a long felt need for seals, sealing elements, packers, conduits fitted with packers, seals and sealing elements that can communicate to the user the degree to which the seal has expanded thereby alerting the user to possible malfunction of the seal during operation of the well.

In addition, during some drilling operations it can become necessary to form a plurality of cavities in order to sequentially remove subterranean deposits. The failure of one or more seals between segregated cavities can cause the formation of an undesirable mixture of two deposits, for example, water and hydrocarbons. Therefore, there is a long felt need for a system that allows for verification of the status and properties of a subterranean wellbore seal.

### BRIEF DESCRIPTION OF THE FIGURES

It is to be noted that the appended figures illustrate only typical embodiments, and do not limit the scope of the disclosure, as there may be other and equally effective embodiments that one skilled in the art would recognize which are within the scope of the disclosure.

FIG. 1 depicts a packer 100 having a single disclosed apparatus 102 deposed circumferentially about a conduit or mandrel. The elements which comprise apparatus 100 are not depicted.

FIG. 2 depicts a packer 200 having a plurality of disclosed apparatuses 202 deposited circumferentially about a conduit or mandrel. The elements which apparatus 200 are not depicted

FIG. 3A depicts is a perspective sighted along the long axis of a disclosed wellbore packer 300. Annulus 301 is defined by the wall of a conduit (indicated as surface 304 in FIG. 3B) onto which is deposed circumferentially sensor 302 upon which sealing element 303 is circumferentially deposed. Upon activation and expansion of sealing element 303, outer surface 304 is capable of making contact with a sealing surface.

FIG. 3B depicts a cutaway view of the same embodiment as FIG. 3A after insertion into a wellbore casing and activation of the sealing element. The packer comprises sensor 302 and sealing element 303 which has expanded and is in contact with sealing surface 304 which is the inside surface of the wellbore. Sealing of the packer against sealing surface forms lower cavity 305. In this non-limiting embodiment wires 306 and 307 provide electrical communication with a user.

FIG. 4A depicts is a perspective sighted along the long axis of a disclosed wellbore packer 400. Annulus 401 is defined by the wall of a conduit (indicated as surface 404 in FIG. 4B) onto which is deposed circumferentially sealing element 403 upon which sensor 402 is circumferentially deposed. Upon activation and expansion of sealing element 403, outer surface 404 is makes contact with sensor 402.

FIG. 4B depicts a cutaway view of the same embodiment as FIG. 4A after insertion into a wellbore casing and activation of the sealing element. The packer comprises sensor 402 and sealing element 403 which has expanded and caused sensor 402 to make contact with sealing surface 304 which is the inside surface of the wellbore. Sealing of the packer against sealing surface forms lower cavity 405. In this non-limiting embodiment wires 406 and 407 provide electrical communication with a user.

FIG. 5 depicts packer 500 in use comprising an apparatus having embedded sensor 503 and sealing element 502 disposed about conduit 501 wherein sealing element 502 has expanded and is now in contact with sealing surface 504 which is the inner surface of a wellbore. Cavity 505 is formed by the creation of the depicted seal.

FIG. 6A depicts the top view perspective of a disclosed packer 600 comprising a plurality of sensors 601 within a continuous sealing element 602.

FIG. 6B depicts a side cut away view of packer 600 showing the disclosed apparatus circumferentially disposed about conduit 603.

FIG. 7 depicts packer 700 comprising an apparatus comprising sensor 702 and sealing element 703 arranged circumferentially about conduit 701 as depicted in FIGS. 3A and 3B, however, packer 700 further comprises anti-extrusion devices 704 positioned above and below the apparatus.

FIG. 8A depicts packer 800 prior to and after activation in a wellbore.

FIG. 8B depicts packer 800 in use having a distorted sealing element caused by a force applied from below the seal.

FIG. 9 depicts an apparatus as described in Example 1.

FIG. 10A shows the amount of swelling of the activated apparatus described in Example 1 over time.

FIG. 10B shows the change in resistivity over time of the activated apparatus described in Example 1.

FIGS. 11A to 11C depict an embodiment of the disclosed apparatus wherein the sensor and sealing element are attached to the inside surface of a sleeve which can be slid down a wellbore for activation. FIG. 11A depicts the positioning of sealing element 1114 and sensor 1116 inside sleeve 1110. FIG. 11B depicts the apparatus of FIG. 11A slidably positioned into wellbore 1112. FIG. 11C shows the relative positions of one or more apparatuses 1110 and a conduit 1118.

FIGS. 11D and 11E depict another embodiment of the apparatus depicted in FIGS. 11A to 11C wherein sensor 1116 is aligned along the inside against sleeve 1110 and upon activation sealing element 1114 expands and makes contact with conduit 1118 thereby forming a seal.

FIGS. 11F and 11G depict a further embodiment of an apparatus that comprises a sleeve. FIG. 11F shows sleeve 1110 positioned along the inside surface of wellbore 1112 having sealing element 1114 deposed on the inside surface of sleeve 1110. Conduit 1118, having sensor 1116 deposited circumferentially along the outside surface thereof, is position in the wellbore such that sensor 1116 is opposite sealing surface 1114. Upon activation as shown in FIG. 11G, sealing element 1114 expands and makes contact with sensor 1116 thereby forming a seal.

FIG. 12 depicts the apparatus described in Example 2.

FIG. 13 shows the change in resistivity over time of the activated apparatus described in Example 2.

### DETAILED DESCRIPTION

Before the present materials, compounds, compositions, articles, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### GENERAL DEFINITIONS

In this specification and in the claims that follow, reference will be made to a number of terms, which shall be defined to have the following meanings:

All percentages, ratios and proportions herein are by weight, unless otherwise specified. All temperatures are in degrees Celsius (° C.) unless otherwise specified.

A weight percent of a component, unless specifically stated to the contrary, is based on the total weight of the formulation or composition in which the component is included.

“Admixture” or “blend” is generally used herein means a physical combination of two or more different components

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed, then “less than or equal to” the value, “greater than or equal to the value,” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

The term “piezoresistive” means the property of a material, whether a single compound or a mixture of compounds, wherein physical deformation of the material results in a change in the electrical properties of the material, for example, the electrical resistivity, independent of the cause of the physical deformation. Non-limiting examples of forces which can cause a deformation in a material resulting in a change in electrical properties includes stress, strain, pressure, temperature, or contact with various fluids and/or gases.

The term “piezoresistive material” is a material that exhibits piezoresistive behavior as defined herein.

The terms “electrical contact” or “electrical communication” mean that two materials are disposed in a manner such that an electrical current is capable of flowing between two materials.

The term “lateral resolution” means the accuracy in measuring the distance between two points on a surface wherein a force has been applied to each point either simultaneously or in series. As such, the greater the lateral resolution the higher the accuracy in determining the location at which a force is applied to one or more locations on a surface.

The term “packer” means a device or system designed to be deployed within a subterranean wellbore and for creating a seal within the wellbore. In one aspect, a packer comprises a tubular member and a sealing element disposed about the tubular member.

The term “swellable” means the ability of a material to increase in size, i.e., swell when acted upon by one or more activating means. The increase in size, for example, expansion in one or more direction, can be activated by, inter alia, by absorption, adsorption, osmosis, or any other means described further herein. As used herein as it relates to the disclosed sealing element, the sealing element is capable of expanding in volume in any and all directions, for example, to fill a space. The swellable sealing element can be formed to expand in a single direction or in multiple directions as chosen by the user.

The term “swell rate” shall mean the rate with which a composition swells or otherwise increases in volume.

The term “activating” means a material, whether liquid, solid, or gaseous, or any combination thereof, that can cause a swellable composition to increase in volume or size in any manner as described herein.

The terms “conduit” and “mandrel” are used throughout the description to mean a tube onto which the disclosed seals are applied and which is further inserted into the wellbore. Conduit and mandrel in their most general meaning can be a pipe or hollow tube, although each can comprise other elements not specifically disclosed herein.

The term “packer” as used herein is a device that can be run into a wellbore having a smaller initial outside diameter such that when the packer expands a seal is created within the wellbore. The disclosed packer can comprise further elements not specifically disclosed herein and which can function in combination with or in accordance with the disclosed sealing apparatuses. For example, a packer can include the conduit to which it is affixed, as well as other items known to those of skill in the art.

The term “sleeve” means a tubular piece, for example, metal, polymer or composite material that is hollow and can slidably be inserted into a wellbore wherein the inside diameter is less than the outside diameter of a conduit that is inserted therein.

The term “resistivity” means an intrinsic property of a material, related to the conduction of electricity, or passage of an electrical current. For example, the disclosed piezoresistive compositions can have a particular resistivity as described herein. The disclosed compositions before being acted upon by a force will have an “initial resistivity.” After being acted upon by a force and the force is subsequently removed the composition will have a “recovered resistivity.” The recovered resistivity can have any value equal to, less than, or greater than the initial resistivity.

The term “resistance” means an extrinsic property of a particular circuit, as in Ohm's law: E=iR where E is the potential difference across a conductor, i is the current through the conductor, and R is the resistance of the circuit. For example, as described herein, a disclosed piezoresistive composition, possessing a certain resistivity, can be part of a circuit comprising the piezoresistive composition and at least two electrodes. The circuit thus comprised will have a certain resistance.

The present disclosure provides an apparatus that when activated is capable of forming a seal in a wellbore and is capable of communicating the status of the seal. The present disclosure also provides a system for using the disclosed sealing apparatus to form one or more seals in a wellbore and communicating the status of the seals either individually or together.

### Apparatus

Disclosed herein is an apparatus for forming a seal in a wellbore, for example, a wellbore or a borehole used in petroleum, natural gas, or other drilling operations. The site at which the seal is formed can be in any position along the boreholes. For example, the seal can be formed along a vertical or a horizontal portion of the wellbore or plurality of seals can be positioned along any portion of the wellbore.

The disclosed apparatus comprises:

a) at least one expandable sealing element; and

b) at least one sensor;

wherein each sensor contains at least one pair of electrodes that can be used to communicate to the user the status of the seal being formed.

In one embodiment, the disclosed apparatus comprises:
a) one or more sealing elements capable of being activated; and
b) one or more sensors for detecting the degree to which the sealing element has been activated;
   wherein the one or more sealing elements are in electrical communication with a system for controlling the activating means.

In one aspect the apparatus comprises at least one sensor wherein the at least one sensor comprises at least about 0.1% of the piezoresistive composition as described herein. In one embodiment, a plurality of piezoresistive compositions are present that each comprise at least about 0.1% of the disclosed piezoresistive composition. For example, a sensor can have a mass of 10,000 grams and a portion of which sensor is a thin film or layer of piezoresistive material. In this non-limiting example, the sensor will comprise at least about 10 grams of piezoresistive composition. The piezoresistive composition can be along one or all surface, i.e., a coating, or the sensor can be fabricated so the piezoresistive material is located in strands or filaments within the sensor.

In use, the disclosed apparatus can be configured in any manner chosen by the user. Disclosed herein are non-limiting embodiments of possible configurations.

In one embodiment the apparatus is selectively positioned along the outside of a conduit or mandrel that is inserted into the wellbore. The conduit as defined herein is a hollow tube for insertion into the wellbore. The conduit can be rigid or flexible and can include one or more other auxiliary tubes or conduits inserted therein. For example, an auxiliary conduit can be used to supply a means for electrical communication between the electrodes and the user. Alternatively the auxiliary conduits can be used for any purpose chosen by the user.

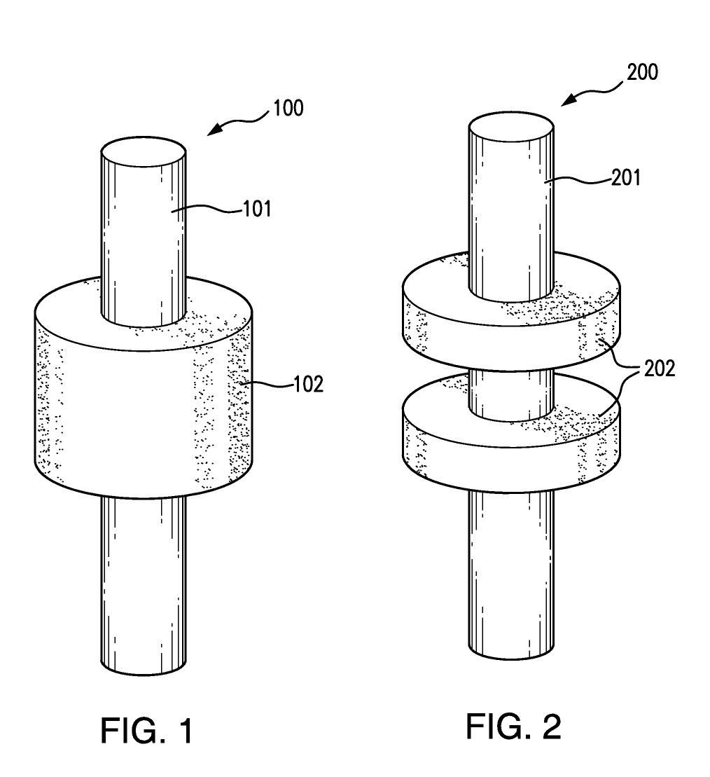

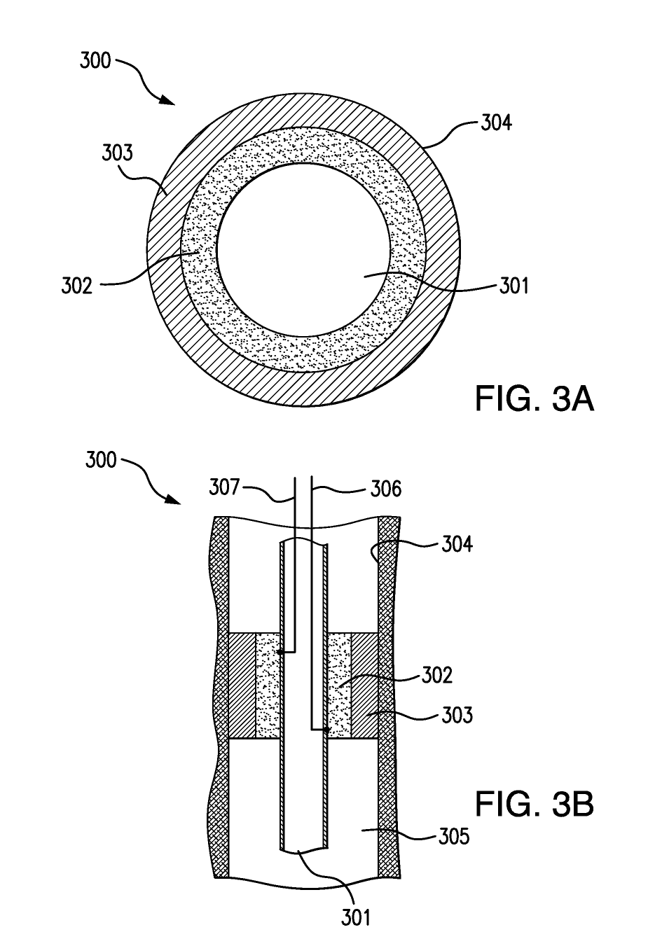

In an iteration of this embodiment, as generally depicted in FIG. 1, a single apparatus 102 is selectively positioned along the outside surface of conduit 101. FIG. 3A shows a detailed top view. In this example, sensor 302 is positioned circumferentially along the outside surface of conduit 301 and sealing element 303, in turn, is positioned circumferentially along the outside surface of sensor 302. For the sake of this general description electrodes and means for electrical communication with the user have been omitted. The diameter of the apparatus shown in FIG. 3A will have an outside diameter smaller than the inside diameter of the wellbore into which it is positioned.

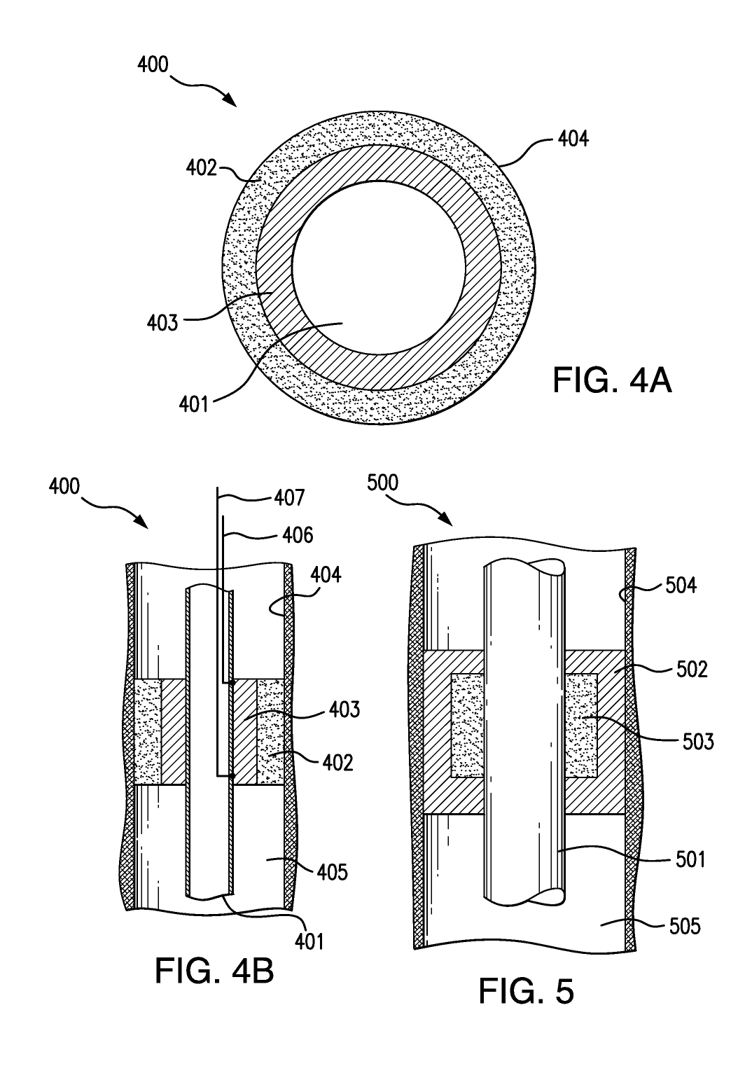

FIG. 3B provides a cut away view of the apparatus 300 depicted in FIG. 3A in use in a wellbore. Sealing element 303 has expanded thereby making contact with sealing surface 304 which in this example is the inside surface of the wellbore. As detailed further herein, as sealing element 303 expands against sealing surface 304 it also applies a sealing force against sensor 302 thereby deforming sensor 302. The deforming of sensor 302 causes a change in the resistivity of the composition that comprises the sensor 302. As depicted in FIG. 3B the expansion of sealing element 303 forms cavity 305 which is now separated from annulus 304. This change in resistivity is measurable and quantifiable as described further herein. FIG. 3B also depicts a means for communication with a user. Wires 306 and 307 are in electrical communication with the piezoresistive composition that comprises sensor 302. The wires can be embedded in the inside surface of conduit 301 or the wires 306 and 307 can be sealed onto the inside surface of conduit 301 using any means chosen by the user, i.e., lamination. FIG. 4B depicts another configuration of the means for communication.

FIG. 2 shows a disclosed system 200 wherein a series of apparatuses 202 are positioned on conduit 201. The apparatus configured in this manner can be used to form a plurality of seals, either at the same time or sequentially.

FIG. 4A depicts system 400 wherein the sealing element 403 is positioned circumferentially along the outside surface of conduit 401 and sensor 402, in turn, is positioned circumferentially along the outside surface of sealing element 403.

FIG. 4B provides a cut away view of the apparatus 400 depicted in FIG. 4A in use in a wellbore. Sealing element 403 has expanded thereby forcing sensor 402 to make contact with sealing surface 404 which again is the inside surface of the wellbore. As depicted in FIG. 4B the expansion of sealing element 402 forms cavity 405 below seal.

FIG. 5 depicts apparatus 500 in use. This embodiment positions sensor 503 is contained entirely within sealing element 502 that is circumferentially disposed on conduit 501. Upon expansion sealing element impinges upon sealing surface 504 thereby forming a seal which also results in formation of cavity 505.

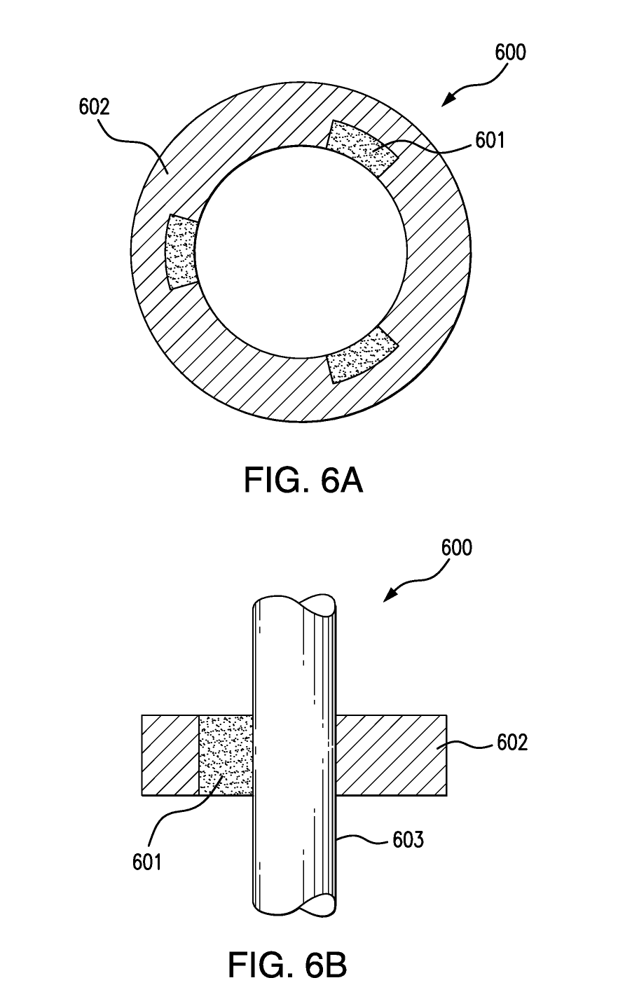

FIGS. 6A and 6B depict a further embodiment of the disclosed apparatus. FIG. 6A is the top view of apparatus 600 wherein sensors 601 are evenly positioned along the outside of conduit 603 and are entirely encased or embedded within sealing element 602. FIG. 6B is a side view of this embodiment.

The non-limiting embodiments depicted in FIGS. 1 to 6B indicate the adaptability of the disclosed apparatus to alternative configurations desired by the user.

### Sealing Elements

As set forth herein, the sealing elements are capable of expanding to form a seal when contacting a sealing surface. The following are non-limiting examples of materials which can comprise the disclosed sealing elements. As disclosed herein the sealing element can be homogeneous or heterogeneous. For example, the outer edges of the sealing element can comprise a different composition. This can be important when the sealing surface is not a smooth surface, but an irregular surface, for example, a wellbore that does not comprise a sleeve or casing inserted into the raw hole or open hole. As such, the sealing element can expand against the earth instead of a smooth surface.

The disclosed sealing elements can be activated by various means, for example, by applying a force to the top of the sealing element causing expansion, or by addition of a fluid which causes the sealing element to expand, or swell. For example, the activating means can be one or more liquids, gases or a combination thereof. For example, the activating means can be a composition which is commonly found, encountered, or utilized during wellbore operations such as during, the drilling, the completion, or the production phases of oil, gas, or geothermal wells. Non-limiting examples of fluids include drilling fluids, completion fluids, stimulating fluids, and acidizing fluids. As such, the fluid can be hydrocarbon based, oil based, water based, or an emulsion or inverted emulsion. In use, in one non-limiting iteration a fluid is used as the activating means. In one example, “diesel” can be used as the activating means. For the purposes of the present disclosure and this non-limiting example, diesel is the fractional distillate at atmospheric pressure of petroleum between about 200° C. and 350° C. Selection by the user of the composition comprising the sealing element will determine the rate and degree of expansion of the sealing element by an activating means.

In one aspect, the sealing element comprises one or more non-metallic materials such as a polymer or polymer composite. For example, the sealing element can comprise an elastomer, a thermoplastic, or a combination thereof. In one embodiment, the sealing element comprises an elastomer. On category of suitable elastomers includes elastomers which have “swellable” properties. Non-limiting examples of these elastomers include ethylene-propylene-copolymer rubber, ethylene propylene diene monomer rubber, ethylene-propylene-diene terpolymer rubber, butyl rubber, natural rubber, halogenated butyl rubber, styrene butadiene rubber, ethylene vinyl acetate rubber, nitrile butadiene rubber, hydrogenated nitrile butadiene rubber, highly saturated nitrile rubber, chloroprene rubber, polyisoprene, polyisobutylene, polybutadiene, polysiloxane, poly-dimethylsiloxane, and/or mixtures or derivatives thereof. The polymers can be further crosslinked once the sealing element is fabricated, for example, by any known chemical crosslinking processes.

The sealing element can further comprise one or more adjunct ingredients, such as fillers (for example carbon black and silica), plasticizers, processing aids, anti-oxidants, curatives, or other ingredients known in the art of polymer compounding.

The sealing element can also further comprise one or more nanomaterials dispersed therein. As used herein, a nanomaterial is a material having at least one dimension that is less than 100 nm. One type of nanomaterial are the “carbonaceous” nanomaterials, non-limiting examples of which include carbon nanotubes, carbon nanosprings, carbon nanocoils, graphene, graphene-oxide, chemically converted graphene, exfoliated graphite, intercalated graphite, grafoil, carbon nanoonions, vapor grown carbon fibers, pitch based carbon fibers, or polyacrylonitrile (PAN) based carbon fibers. Other forms of carbonaceous nanomaterials are known in the art and are suitable for the disclosure. The nanomaterial can be chemically modified, for example, functionalized or otherwise derivatized. The nanomaterial can be functionalized in any manner determined by the user to facilitate providing the sealing element with the desired properties. In one aspect, the nanomaterial is functionalized in order to provide increased compatibility with the polymeric material into which the nanomaterial is dispersed.

Functionalization of a dispersed nanomaterial can also be used to affect a particular property of the sealing element. For example, degree of expansion, amount or degree of expansion per degree temperature, amount or degree of expansion per unit force applied by the activating means, and the like. The nanomaterial can be functionalized to increase or decrease the swell rate, for example by enhancing or retarding the rate at which an activation means, such as a liquid or a gas, is taken up by the sealing element.

In other aspect, functionalization can alter the equilibrium concentration of an activating means within the polymer comprising the expandable sealing element, and thereby alter the equilibrium volume of the expandable sealing element. The equilibrium concentration represents the maximum amount of an activating means that can be present within the sealing element under a fixed set of conditions. The equilibrium volume represents the maximum attainable volume of the sealing element under a fixed set of conditions. In one aspect, functionalization of the nanomaterial dispersed in the polymer composition can increase the equilibrium concentration of an activation means within the expandable sealing element, thereby increasing the equilibrium volume of the expandable sealing element and further the force with which the sealing element impinges upon a surface or surfaces. In another aspect, functionalization of the nanomaterial dispersed in the polymer composition can decrease the equilibrium concentration of an activating means within the expandable sealing element, thereby decreasing the equilibrium volume.

The plurality of nanomaterials can be of one type, for example carbon nanotubes, or can be a mixture of more than one type of nanomaterial, for example a mixture of carbon nanotubes and graphene. The plurality of nanomaterials can comprise any combination of nanomaterials in any ratio or ratios.

In one aspect, the disclosed sealing element comprises:

a) from about 50% to about 99.99% by weight of one or more polymers; and

b) from about 0.01% to about 50% by weight of one or more nanomaterials.

In another aspect, the sealing element comprises:

a) from about 60% to about 99.99% by weight of one or more polymers; and

b) from about 0.01% to about 40% by weight of one or more nanomaterials.

In a further aspect, the sealing element comprises:

a) from about 70% to about 99.99% by weight of one or more polymers; and

b) from about 0.01% to about 30% by weight of one or more nanomaterials.

In a yet further aspect, the sealing element comprises:

a) from about 80% to about 99.99% by weight of one or more polymers; and

b) from about 0.01% to about 20% by weight of one or more nanomaterials.

In yet another aspect, the sealing element comprises:

a) from about 90% to about 99.99% by weight of one or more polymers; and

b) from about 0.01% to about 10% by weight of one or more nanomaterials.

In still another aspect, the sealing element comprises:

a) from about 95% to about 99.99% by weight of one or more polymers; and

b) from about 0.01% to about 5% by weight of one or more nanomaterials.

In one aspect, both the expandability (swell rate) and the equilibrium volume of the polymer composition are inversely proportional to the amount of nanomaterial dispersed in the polymer, i.e., a greater amount of nanomaterial leads to a reduced expansion rate and a lower equilibrium volume of the composition. In addition, the greater the amount of nanomaterial, the higher the observed elastic modulus of the sealing element, including tensile, compressive, and shear modes of deformation. These factors affect the utility of the sealing element with respect to expansion rate, equilibrium swell, and extrusion resistance, or differential pressure holding capability.

The nanomaterial can be uniformly distributed throughout the polymer composition. In other aspects, the nanomaterial can be dispersed within the polymer composition in a non-uniform manner. For example, the nanomaterial can be preferentially localized in certain regions of the polymer composition. In another aspect wherein the polymer composition comprises more than one polymer, the nanomaterial can be located within one polymer and not in others. As such, this aspect means a complete absence of nanomaterial in one or more regions where the particular polymer is located within the sealing element while all of the nanomaterial present is located in one or more other regions. Alternatively, the nanomaterial concentration in one region or regions of the sealing element is higher than in another region or regions although all such regions can comprise nanomaterial. In a further example, the nanomaterial can be located in a particular region or segment of the sealing element, for example near the outer edge, near the inner edge, or in a particular region, segment, or band in between the outer edge and the inner edge. In one aspect, the nanomaterial can be dispersed in such a way as to create a nanomaterial concentration gradient which changes in either a progressive (gradient) or quantum manner in a horizontal, vertical, radial, or azimuthal direction within the sealing element. Because the local concentration of nanomaterial can affect the swell rate or equilibrium volume of the sealing element as described herein, a non-uniform dispersion of the nanomaterial is useful to tune the local expanding behavior of the sealing element. For example, in conventional expandable sealing elements that are vertically disposed in a wellbore, the top and bottom ends can expand (swell) at a faster rate than the center due to increased exposure to an activation means and to decreased physical constraint. This results in an uneven swell rate across the profile of the sealing element. By employing a non-uniform dispersion of nanomaterial wherein the nanomaterial concentration is highest at top and bottom while decreasing towards the center of the sealing element, one can achieve a more uniform swell rate across the vertical profile of the sealing element. In another aspect, one or both of the expansion rate and the equilibrium volume of the sealing element are non-uniform due to a non-uniform concentration of nanomaterial within the polymeric composition. An alternative approach in achieving non-uniform expanding of an expandable sealing element is disclosed in US 2011/0120733 which is incorporated herein by reference in its entirety.

### Sensor

Disclosed herein are sensors that can detect the presence of a force applied thereto, i.e., the degree to which the sealing element has expanded. As such, the sensor can be used in conjunction with the sealing element to determine the position of sealing element expansion, the amount of sealing element expansion, as well as the integrity of the seal.

The disclosed sensors exhibit piezoresistive properties in that a fixed current passing between two electrodes in contact with the sensor will have an initial measurable resistance. As such, the sensor is a piezoresistive composition all or in part. Upon deformation of the sensor by a force, for example, expansion of the sealing element, the resistivity of the sensor will change. This change can be identified by the user, for example, by measuring the corresponding change in current flow. Alternatively, the user can adjust the operating parameters of the current source such that what is measured is the resulting in observed resistance. The method by which the change is observed is, however, left to the choice of the user.

In another aspect the disclosed sensors comprise at least about 1% by weight of a piezoresistive composition. In a further aspect the disclosed sensors comprise at least about 10% by weight of a piezoresistive composition. In a yet further aspect the disclosed sensors comprise at least about 25% by weight of a piezoresistive composition. In a still further aspect the disclosed sensors comprise at least about 50% by weight of a piezoresistive composition. In a yet another aspect the disclosed sensors comprise at least about 75% by weight of a piezoresistive composition. In a still yet further aspect the disclosed sensors comprise 100% by weight of a piezoresistive composition.

The disclosed sensors comprises:

i) one or more polymers; and

ii) a plurality of conductive elements dispersed therein.

In one aspect, the disclosed sensors comprise:

i) one or more polymers;

ii) a plurality of conductive elements dispersed therein; and

iii) carbon black.

In a further aspect, the disclosed sensors comprise:

i) one or more polymers;

ii) a plurality of conductive elements dispersed therein; and

iii) one or more adjunct ingredients.

In certain embodiments of the disclosed sensors, the plurality of conductive elements comprises a mixture of more than one type of conductive elements. In certain further embodiments the plurality of conductive elements comprises a mixture of more than one type of conductive elements wherein at least one type of conductive element is a nanomaterial. As used herein, nanomaterial is a conductive element wherein at least one of the dimensions is less than 100 nm in length.

In a further aspect, the conductive element can comprise a carbonaceous material. Non-limiting examples of suitable carbonaceous materials include: carbon nanotubes, carbon nanosprings, carbon nanocoils, graphene, graphene-oxide, chemically converted graphene, exfoliated graphite, intercalated graphite, grafoil, carbon nanoonions, vapor grown carbon fibers, pitch based carbon fibers, or polyacrylonitrile (PAN) based carbon fibers.

In another aspect, the sensors comprise carbon black [C.A.S. NO. 1333-86-4]. Carbon black is virtually pure elemental carbon in the form of colloidal particles that are produced by incomplete combustion or thermal decomposition of gaseous or liquid hydrocarbons under controlled conditions. A still yet further embodiment relates to the use of two or more (a plurality) conductive elements in combination.

In another aspect, the piezoresistive composition can be an admixture of two or more conductive elements. In one embodiment, this admixture of conductive elements can be dispersed homogeneously throughout the piezoresistive composition. In another embodiment, the formulator can disperse different conductive elements at different locations within the composition. This can be done to increase or decrease the electrical conductivity and to increase precision in measuring applied forces.

The polymers that can comprise the disclosed sensors can belong to one or more of the following non-limiting general classes of polymers, for example, thermoplastic, elastomeric, thermoplastic elastomeric, or thermoset polymers. The polymer can be in any form, for example, amorphous, semi-crystalline, crystalline, liquid crystalline, or a combination thereof. The following are non-limiting examples of elastomeric polymers suitable for use in preparing the disclosed sensors: polyphosphazene elastomers, natural rubber (NR), polyisoprene (IR), butyl rubber (IIR) and halogenated versions thereof, polybutadiene (BR), styrene-butadiene rubber (SBR), nitrile butadiene (NBR) and hydrogenated nitrile butadiene (HNBR), polychloroprene (CR), ethylene propylene rubbers (EPM and EPDM), silicone rubbers (SI, Q, VMQ), polydimethylsiloxane (PDMS) and derivatives, ethylene vinyl acetate (EVA), polymethylmethacrylate (PMMA), fluroroelastomers such as fluorinated ethylene propylene monomer rubber (FEPM, FKM), and perfluroelastomers (FFKM) such as those made by copolymerization of monomers such as tetrafluoroethyelene and hexafluoropropylene.

In another embodiment, the disclosed piezoresistive composition sensor is a piezoresistive membrane as is disclosed in U.S. Provisional Application 61/494,378, included herein by reference in its entirety.

In one aspect of these embodiments, the polymer comprising the piezoresistive composition is similar to the polymer comprising the sealing element, irrespective of adjunct components. In another aspect, the polymer comprising the piezoresistive composition identical to the polymer comprising the sealing element, e.g. comprising the same primary polymer component. In other aspects, the primary polymer comprising the piezoresistive composition is of a different polymer class than the primary polymer comprising the sealing element. In certain aspects thereof, the primary polymer comprising the piezoresistive composition chemically complements the primary polymer comprising the sealing element. In certain aspects the piezoresistive composition fulfills at least one of the following characteristics:
i) chemically compatible with the fluid and/or gases that will come into contact with the piezoresistive composition, meaning that the piezoresistive composition will not suffer significant chemical attack nor loss of ability to function. Examples of relevant fluids include, but are not limited to, hydrocarbon or oil based fluids, hydrocarbon or oil based fluids further comprising additives common to oilfield operations, drilling fluids, completion fluids, wellbore fluids, produced fluids, water, water based fluids further comprising additives common to oilfield operations, fuels, oil, lubricants, grease, silicone grease, and fluorocarbon grease. Relevant gases include, but are not limited to, carbon dioxide, carbon monoxide, hydrogen sulfide, methane, ethane, propane, nitrogen, air, steam, and natural gas. Other relevant liquid, gas, or solid compositions include various activating means as described herein.
ii) has the ability to resist the effects of rapid gas decompression (‘explosive decompression’) as is defined by NACE TMO296 or NORSOK M710 or both.
iii) has the ability to resist extrusion, regardless of mechanism, when subjected to a differential pressure of at least about 500 psi, or at least about 1,000 psi, or at least about 2,000 psi, or at least about 5,000 psi or at least about 10,000 psi, or at least about 15,000 psi.

The piezoresistive composition comprising the disclosed sensor can possess certain physical properties that imbue the disclosed sensor with certain advantages over prior art. For example, the piezoresistive compositions can possess favorable creep, fatigue resistance, and hysteresis properties. In other aspects, the fatigue resistance of the piezoresistive composition comprising the disclosed sensor enables the disclosed sensors to recover any deformation caused by an applied force and thereby to return to or near to its original state. For example, the resistivity is recoverable to about 50% or more, about 60% or more, about 70% or more, about 80% or more, about 90% or more, or about 100% of the original value prior to application of the force. In another aspect the piezoresistive composition can exhibit a low hysteresis with respect to the resistivity change. In one aspect, the hysteresis is less that about 20% of the measured change in resistance. In another aspect, the hysteresis is less that about 10% of the measured change in resistance. In yet another aspect, the hysteresis is less that about 5% of the measured change in resistance. In a still yet further aspect, the hysteresis is less that about 2% of the measured change in resistance. A further advantage of the disclosed piezoresistive compositions relates to low resistivity creep, or change in resistivity, when subjected to a fixed or a constant applied force or pressure. In one iteration of this aspect, the change in resistivity is less than about 30% over a period of from about 5 minutes to about 5 hours under constant or relatively constant force or pressure applied thereto. In another iteration of this aspect, the change in resistivity is less than about 15% over a period of from about 5 minutes to about 5 hours. In a further iteration of this aspect, the change in resistivity is less than about 10% over a period of from about 5 minutes to about 5 hours. In a yet further iteration of this aspect, the change in resistivity is less than about 5% over a period of from about 5 minutes to about 5 hours. In a yet further iteration of this aspect the change in resistivity is less than about 30% over a period of more than about 5 days under constant or relatively constant force or pressure applied thereto.

In one aspect, the resistivity of the piezoresistive composition changes by at least one order of magnitude in response to an applied force or pressure, i.e., from about 100 MOhm to about 10 MOhm, or from about 10 Ohm to about 1 Ohm. In another aspect, the resistivity of the membrane changes by at least two orders of magnitude in response to an applied force. In a further aspect, the resistivity of the membrane changes by at least three orders of magnitude in response to an applied force. In a still further aspect, the resistivity of the membrane changes by at least four orders of magnitude in response to an applied force. In a yet another aspect, the resistivity of the membrane changes by at least five orders of magnitude in response to an applied force.

In yet still another aspect of the disclosed sensors, the piezoresistive composition membrane can exhibit a change in resistivity that corresponds to the amount of a force or pressure acting upon the membrane as determined by the formulator. In one embodiment, the membrane can exhibit a change in resistivity of at least about three orders of magnitude when a force from about 0.01 Newtons (N) to about 20 N is applied thereto. In another aspect, the piezoresistive composition can exhibit a change in resistivity of at least about three orders of magnitude when a force from about 20 Newtons (N) to about 500 N is applied thereto. In certain aspects, the piezoresistive composition can exhibit a change in resistivity of at least about three orders of magnitude when a force greater than about 500 N is applied thereto. In another aspect, the piezoresistive composition comprising the disclosed sensor exhibits a volume change of less than about 50%, less than about 40%, less than about 30%, less than about 20%, or less than about 10% when exposed to the same triggering medium as the disclosed sealing element and for the same period of time.

The disclosed sensor further comprises a means for measuring the electrical properties of the piezoresistive composition. In certain aspects, the means for measuring the electrical properties comprise microelectromechanical (MEMS) technology. In other aspects, the means for measuring the electrical properties of the piezoresistive composition comprises more than one electrode, wherein the electrodes are spatially displaced one from another. In one aspect, the electrodes comprise metallic electrodes, such as copper electrodes. The electrodes can be disposed on one side or face of the piezoresistive composition, or can be disposed on opposite sides or faces of the piezoresistive composition. Other metallic compositions that can serve as electrodes are known in the art, and the disclosure is not limited in this respect. In one aspect, the more than one electrode can comprise an array of Schottky diodes. In one aspect the diodes comprising the Schottky diode array are supported on or affixed to a substrate, and are further in contact with the piezoresistive composition. The diodes or electrodes can placed arranged in a regular pattern, or array, such that the spacing between electrodes is uniform and fixed. In one aspect the individual electrodes are also uniform in size. In another aspect, the electrodes vary in size, or may be grouped by size. The size, spacing, and otherwise arrangement of the electrodes is chosen depending on the desired spatial resolution of the resistivity measurements. For example, in certain aspects it is desirable to achieve a high spatial resolution, thereby necessitating small spacing between the electrodes, for example less than about 5 micrometer. In other aspects, the spacing between the electrodes can be from about 5 micrometer to about 2000 micrometer. In another aspect, the electrodes are arranged in an array, such as, for example, a 2×2, 3×3, 4×4, 16×16 or 1×2, 2×4, 4×8, etc. arrays. The array can be of any suitable configuration or size, and the disclosure is not limited in this respect. The size of the individual electrodes is similarly chosen to be suitable for a particular end use. For example, in certain aspects, the electrodes may be from about 1 micrometer to about 2000 micrometer in diameter. In other aspects, the electrode may be from about 10 micrometer to about 100 micrometer, or from about 20 micrometer to about 100 micrometer, or from about 30 micrometer to about 100 micrometer. The electrodes themselves may function as a component of a transistor, (source, drain, or gate), a diode, or a resistor. Provision is made for electrical communication between at least a portion of and as many as all of the electrodes. Further provision is made for connection or communication with the outside world. In one aspect, each individual electrode is electrically addressable. In another aspect, groups or arrays of electrodes are electrically addressable as a group. In one aspect, passive circuitry is employed for the purpose of addressing the electrode or electrodes. In another aspect, active matrix circuitry can be used for the purpose of addressing the electrode or electrodes. In one aspect the circuitry is fabricated using thin film circuitry with amorphous Si as the active semiconductor. Other semiconductors are also suitable, such as, for example, semiconductors from Groups II-VI of the Periodic Table of Elements, such as CdS, ZnO, InZnO, and InGaZnO. Organic-based transistors are also suitable for the disclosure. In various aspects, the array is fabricated by photolithography, inkjet or reel-to-reel methods. The electrodes and active components of the diodes can be deposited onto or affixed to the substrate by one or more means, such as vapor deposition, lithography, ink jet printing, or screen printing. Other means of electrode deposition are known in the art and are suitable for the disclosure. In certain aspects, the electrodes are arranged in such as a way that the device is capable of geographically locating a change in resistance of the piezoresistive composition of the disclosure. For example, a certain electrode or set of electrodes will detect a change in resistance, whereas other electrode(s) spatially displaced from the first electrode or set of electrodes will detect a smaller change or no change in resistance. In certain aspects, the change in resistance, whether local or global, is able to be translated into a local or global applied force. The disclosed sensor can be operable to measure changes in the ‘in-plane’ electrical properties of the piezoresistive composition, or can be operable to measure changes in the ‘through-plane’ electrical properties of the piezoresistive composition. The preferred arrangement is determined in light of the overall apparatus configuration.

In one embodiment, the piezoresistive composition is in intimate contact with the electrodes, meaning that electrical current can flow between the electrodes via the bridging piezoresistive composition. Herein, the measured resistance in a state of zero applied force or pressure can still be high, for example at least about 0.1 MOhm, or at least about 1 MOhm, or at least about 10 MOhm, or at least about 100 MOhm, or higher. In this embodiment, it is the piezoresistive nature of the piezoresistive composition that results in a change in resistance between the electrodes upon the application of a force or pressure to the piezoresistive composition.

In another embodiment, the piezoresistive composition and at least two electrodes does not depend on a piezoresistive nature of the piezoresistive composition. In this embodiment, the sensor is can provide measurements as described herein, but the change in measured electrical properties is due to variable contact between the piezoresistive composition and the electrodes. Thus, the application of a force or pressure to the piezoresistive composition causes an increase in the contact surface area between the piezoresistive composition and the electrodes, or an increase in the number of points of contact between the piezoresistive composition and the electrodes, or both. Either case results in a reduced measured resistance between the at least two electrodes, and enables the sensor to operate as described herein.

In one aspect, the piezoresistive composition comprising the disclosed sensor is at least about 10 μm, or at least about 100 μm, or at least about 500 μm, or at least about 1,000 μm, or at least about 10,000 μm in thickness.

In another aspect, the piezoresistive composition exhibits a volume swell of less than about 50%, less than about 25%, or less than about 5% when exposed to a medium comprising the activating means that the disclosed sealing element is exposed to, as described herein, for a period of at least about 12 hr. In yet another aspect, the piezoresistive composition exhibits approximately the same volume swell as the disclosed sealing element that the sensor is disposed in relation to, upon exposure to a medium comprising the activating means for any period of time. For example the swell of the piezoresistive composition can be less than about 30%, less than about 20%, less than about 10%, or less than about 5% difference, either greater or lesser, than the swell exhibited by the sealing element.

In one aspect, the sensor of the disclosure has a lateral resolution from at least about 100 μm, at least about 500 μm, at least about 500 μm, or at least about 1,000 μm. In another aspect, the sensor of the disclosure has a lateral resolution of at least about 1 cm, at least about 10 cm, at least about 100 cm, or at least about 1 m. Herein, lateral resolution means the minimum distance over which the sensor is operable to make spatially independent measurements of a force or pressure applied thereto. For example, a sensor with a lateral resolution of at least about 100 cm can distinguish between the force or pressure applied to the piezoresistive composition at points separated by at least about 100 cm, and to make independent determinations thereof.

In certain aspects, the sensor of the disclosure can detect or measure a force applied thereto by a sealing element of at least about 100 N, at least about 200 N, at least about 500 N, at least about 750 N, at least about 1,000 N, or at least about 1,250 N. In further embodiments, the disclosed sensors can measure the pressure applied thereto by a sealing element of at least about 100 N cm⁻², at least about 200 N cm⁻², at least about 500 N cm⁻², at least about 1,000 N cm⁻², or at least about 1250 N cm⁻².

The disclosure further provides for peripheral electronics to communicate with the sensor, to gather and transmit data, and to apply software based algorithms to the data to result in a user readable or actionable information format.

In certain aspects, the sensor or more than one sensor are able to provide a two-dimensional or three-dimensional representation of force applied thereto by a sealing element or sealing elements. In a further aspect, the information derived from the sensor is useful to suggest design changes to the sealing element, to the housing, apparatus, or tool comprising the sealing element, or to the means of activating, engaging, or setting the sealing element. In one embodiment, sensor of the disclosure transmits data wirelessly to a remote central data station for further processing. In certain aspects, the wireless transmission is by means of radio frequency transmission, or by other electromagnetic frequencies, for example in the Gigahertz range.

In various aspects, the disclosed sensor can operate a range of temperatures of from about 0° C. to about 300° C.

Without limitation, disclosed herein are the following:

An apparatus for forming a seal in a wellbore, comprising:

a) one or more expandable sealing elements; and

b) at least one sensor;

wherein at least about 0.1% by weight of the sensor comprises a piezoresistive composition.

An apparatus for forming a seal in a wellbore, comprising:
A) a conduit having deposed circumferentially along the outside thereof:
   i) one or more sensors; and
   ii) one or more sealing elements; and
B) a means for electrical communication between the one or more sensors and a user.

An apparatus for forming a seal in a wellbore, comprising:
A) a sleeve for insertion into a wellbore along the inside surface of the wellbore wherein the outside surface of the sleeve is slidably attached to the inside surface of the wellbore, the sleeve having deposited along the inside surface:
   i) one or more sensors; and
   ii) one or more sealing elements; and
B) a means for electrical communication between the one or more sensors and a user.

An apparatus for forming a seal in a wellbore, comprising:
A) a circular sleeve for insertion into a wellbore along the inside surface of the wellbore wherein the outside surface of the sleeve is slidably attached to the inside surface of the wellbore, the sleeve having deposited along the inside surface one or more sealing elements;
B) a conduit having deposed circumferentially along the outside circumference thereof one or more sensors; and
C) a means for electrical communication between the one or more sensors and a user.

An apparatus for forming a seal in a wellbore, comprising:
A) a circular sleeve for insertion into a wellbore along the inside surface of the wellbore wherein the outside surface of the sleeve is slidably attached to the inside surface of the wellbore, the sleeve having deposited along the inside surface one or more sensors;
B) a conduit having deposed circumferentially along the outside circumference thereof one or more sealing elements; and
C) a means for electrical communication between the one or more sensors and a user.

### Packer

As described herein, the apparatus can be configured for use as a packer in a subterranean wellbore. When configured as a packer, for example, in FIGS. 1 and 2 and in use as depicted in FIG. 3B, the outside diameter of the apparatus as attached to the conduit is less than the inside diameter of the wellbore into which the packer is inserted. FIGS. 1 to 8B and 11A to 11G depict embodiments of the disclosed apparatuses configured for use as a packer.

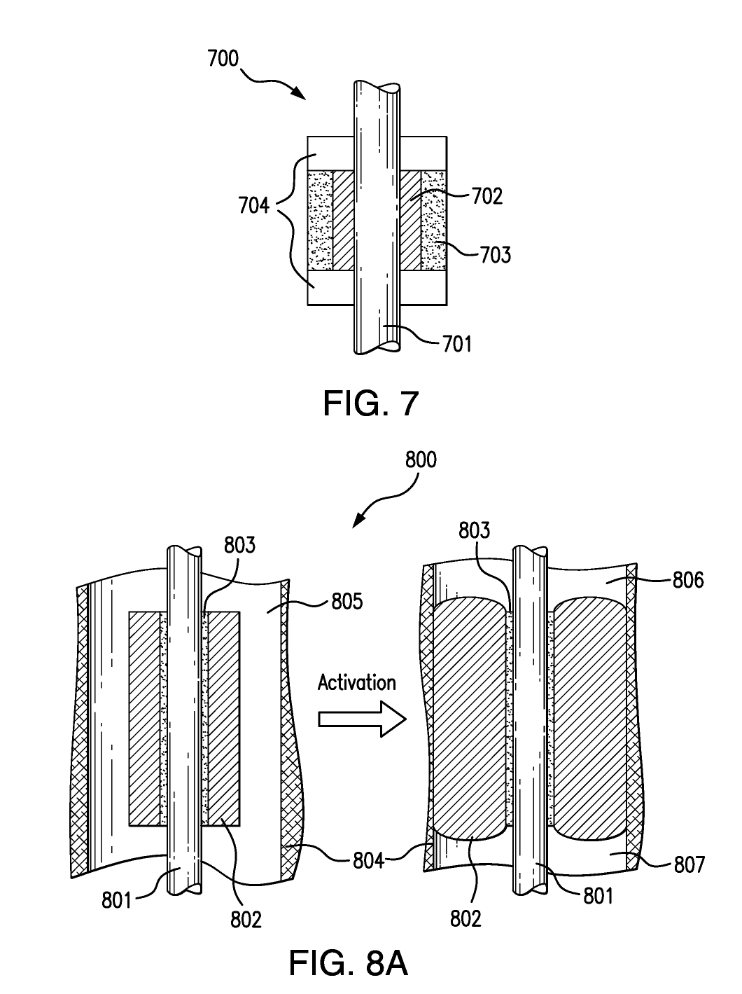

In one aspect, the disclosed packer can comprise anti-extrusion devices disposed immediately above and below the apparatus. FIG. 7 depicts packer 700, comprising a conduit 701, a sensor 702, an expandable sealing element 703. Anti-extrusion devices 704 are positioned immediately above and below the apparatus which comprises sensor 702 and expandable sealing element 703. The anti-extrusion devices can be metallic or non-metallic compositions designed to prevent extrusion, or flow of the sealing element into a gap in response to differential pressure.

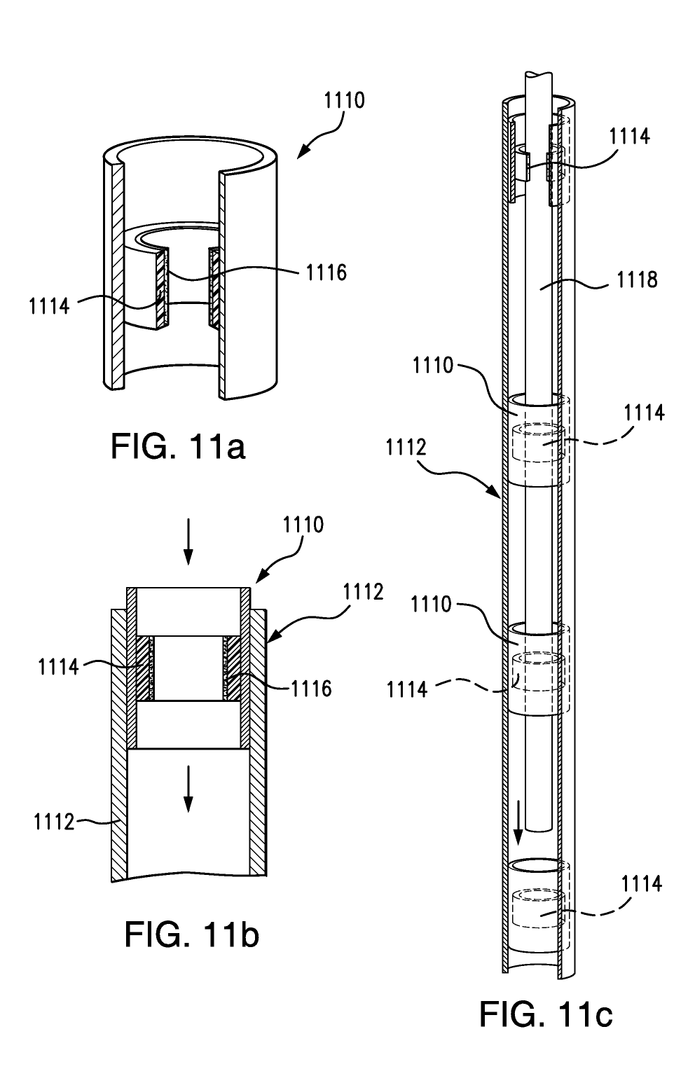

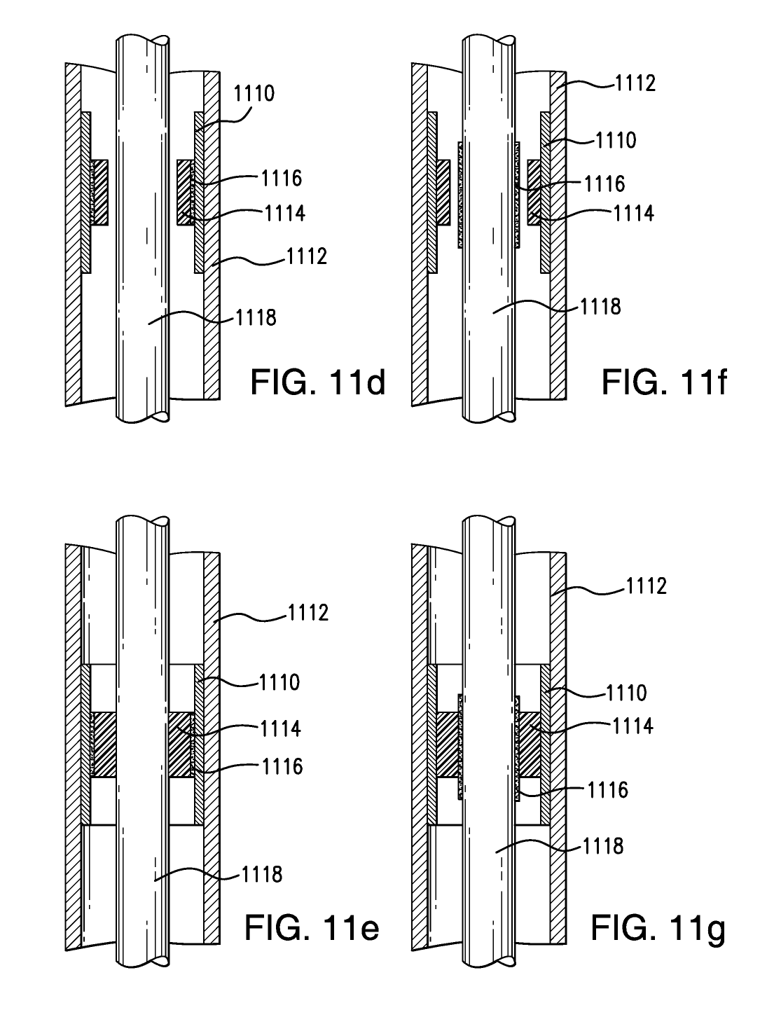

Further disclosed herein is a packer assembly that can comprise a disclosed apparatus that can be inserted into a wellbore independently of a conduit, i.e., the apparatus is slid down the wellbore and hence prior to activation as described herein is “slidably” attached to the wellbore wall. FIG. 11A depicts an apparatus for slidable insertion into a wellbore. The sensor comprises sleeve 1110 and sealing element 114 and sensor 1116 which arranged circumferentially along the inside of the sleeve. As depicted in FIG. 11B the apparatus 1110 can be inserted into a wellbore 1112. The inside diameter of the apparatus along the sensor is larger than the diameter of a prospective conduit to be inserted into the wellbore. FIG. 11C depicts the positioning of apparatus 1110 into wellbore 1112 followed by insertion of conduit 1118. Sleeve 1110 can be electrically conductive, i.e., a metal or composite material or sleeve 1110 can be electrically non-conductive.

FIGS. 11D and 11E depict another embodiment of this aspect of the disclosed apparatus. FIG. 11D shows the apparatus inserted “down hole” in wellbore 1112 wherein Sleeve 1110 is slidably in register with the inside surface of wellbore 1112 and conduit 1118 has been inserted therein. Deposed circumferentially along the inside surface of sleeve 1110 is sensor 1116 which in turn has expandable sealing element 1114 deposited thereon. As shown, there is a space or annulus between the outside surface of conduit 1118 and the inside surface of expandable sealing element 1114. Upon activation of the apparatus as depicted in FIG. 11E, sealing element 1114 expands horizontally and makes contact with conduit 1118. The expansion of sealing element 1114 causes a force to be exerted against sensor 1116 and the resulting change in resistivity can be used to indicate a seal has formed.

The apparatus depicted in FIGS. 11A to 11E provides several advantages to the user. The apparatus can be lowered until the bottom of the sleeve reaches a particular depth. The sleeve thickness can be adjusted to any thickness desired by the user. In one aspect, the apparatus can comprise a flexible sleeve for insertion first vertically then into a horizontal area of the wellbore. In the embodiment depicted in FIGS. 11D and 11E, the means for electrical communication can be implanted into the sleeve such that the electrodes protrude from the sleeve into the sensor.

FIGS. 11F and 11G depict a further embodiment of the disclosed apparatus. As shown in FIG. 11F sensor 1116 is circumferentially deposited along the outside surface of conduit 1118 whereas the sealing element is deposed along the inside surface of sleeve 1110. When the apparatus is activated as shown in FIG. 11G, the sealing element expands outward to make contact with sensor 1116. Expansion against wellbore 1112 in both embodiments fixes the apparatus in place; as such the apparatus can no longer be slid up and down the wellbore.

The apparatuses depicted in FIGS. 11A to 11G can be stacked by the user. One convenient means for stacking relates to inserting between two apparatuses a sleeve that comprises the same material the sleeve which has the expandable sealing element. Alternatively sleeve 1110 can have a longer length such that two consecutive apparatuses that are slid into a wellbore will have a pre-determined distance between sealing elements.

In one embodiment, the sleeve can comprise a continuous opening or slit vertically along one side to facilitate expansion onto the inner wall of the wellbore when the sealing element expands. In another embodiment, the sleeve comprises a composite material or polymer which is capable of expanding outward to the surface of the wellbore,

When more than one apparatus is intended for use, the sensor, i.e., the piezoresistive composition can be applied either continuously over the outside surface of the conduit, or cuts or breaks in the piezoresistive material can be made to isolate sections of the sensor. In this manner, when the user is faced with isolating segments of the annulus that exists between the wellbore and the conduit, the change in resistivity that is detected along any segment of the conduit will provide the user with information regarding the location of the wellbore seal that has formed.

In one configuration of the disclosed apparatus for use as a packer, a disclosed sensor is disposed along at least a portion of the conduit between the sealing element and the conduit. Packers in this configuration can be prepared as follows:
i) affixing an insulating (i.e., not electrically conductive) material to a conduit at a desired location, whose footprint (i.e., area) is at least as large as the footprint of the sensor to be employed, or at least 20% larger, at least about 30% larger, at least about 40% larger, or at least about 50% larger than the footprint of the sensor to be employed, and;
ii) preparing a disclosed sensor, and;
iii) affixing the sensor to the insulating material and thereby to the mandrel;
iv) preparing a sheet of an uncured expandable composition, and;
v) wrapping the sheet of uncured expandable composition to enrobe the previously affixed sensor, and;
vi) curing the expandable composition.

Similar processes are suitable for preparing packers wherein in the sensor is disposed in alternative arrangements as described herein, with suitable alteration in sequence of steps or placement of components; these variations are within the scope of the present disclosure.

In one aspect, the sensor comprising the disclosed packer is capable of providing an on/off signal, or binary signal, i.e., whether a certain pre-determined amount of swell has been achieved or not, or whether a pre-determined amount of force exerted by the sealing element against a mandrel or a sealing surface has been achieved or not. In other aspects, the sensor is able to quantify the amount of swell in the sealing element, the amount of force exerted by the sealing element against the mandrel or a sealing surface, or both. In an aspect wherein more than one sensor (i.e. multiple sensors) are associated with a sealing element, the sensors can measure the swell at different locations or regions of the sealing element. In this manner, an expandion profile can be determined that describes the swell across vertical, horizontal, or azimuthal dimensions of the sealing element. For example, one can determine whether the distal portions of a sealing element are expanding faster than the central portion of a sealing element. In another aspect, the multiple sensors can provide a three dimensional force map, wherein two dimensions are X and Y coordinates of a surface of the sealing element, and the third dimension is the force applied by the sealing element against the mandrel or a sealing surface. In various aspects wherein multiple sensors are associated with a sealing element, the positioning of the sensors in relation to one another can be of any desired relation. For example, the sensors can be arranged in a series, or in an array, wherein the number of sensors comprising the series or array is determined by the desired measurement footprint. The spacing of sensors can likewise be any desired spacing, whereby the spacing is determined by the desired lateral resolution of feedback. For example, a series of three sensors can be positioned with one sensor near the top, one sensor near the bottom, and one sensor near the middle of a sealing element, such as is depicted in FIGS. 6A and 6B. The spacing can be uniform amongst the sensors comprising the series or array, or can be variable. In various aspects, the spacing between the sensors is at least about one inch, at least about six inches, at least about one foot, at least about two feet, or at least about four feet.

In a further aspect, the disclosed packer is able to provide continuous monitoring of the swell state or expansion state of the sealing element. Likewise, the disclosed packer is able to provide continuous monitoring of the force exerted by the expandable sealing element against a mandrel or a sealing surface. In some cases, changes in fluid composition encountered by a sealing element in a subterranean wellbore over time can cause a change in the swell state of the sealing element. For example, a packer comprising an oil expandable sealing element can encounter a high water content fluid at a time after placement in the wellbore, causing a retraction of the sealing element and thereby reduction in or loss of the seal against the sealing surface. Changes in other conditions in the subterranean wellbore can likewise affect the swell state of the sealing element, such as a change in temperature. In any case, it is useful for an operator to be aware of the swell state of the sealing element at various points in time. Furthermore, physical processes common to crosslinked polymer systems that commonly comprise sealing elements, such as stress relaxation, can cause a reduction in the force applied by the sealing element against the mandrel or a sealing surface or both. The presently disclosed packer is able to monitor the effect of these physical changes as well.

In a further aspect, the packer can further comprise an additional layer disposed about the outer diameter of the sealing element, comprising a delay barrier. The delay barrier serves to delay, or inhibit expanding of the sealing element for a period of time, giving time to convey the packer to a desired location or depth within the wellbore. Accordingly, the swell properties of the delay barrier are different from the swell properties of the sealing element. In some aspects, the delay barrier dissolves or otherwise disintegrates over time in the wellbore, further exposing the sealing element to a triggering medium. Additionally, the delay barrier can protect the sealing element from physical damage during transport, storage, or conveyance to a desired location within the wellbore.

The disclosed packer can communicate information from the disclosed sensor or sensors to a location remote from the sensor or sensors via methods known in the art. Non-limiting examples are mud pulse telemetry, electromagnetic telemetry, wireless transmission, or wired pipe.

### Methods

Further disclosed herein are methods for sealing in a subterranean wellbore, forming a seal in a subterranean wellbore, or for closing a subterranean wellbore to create one or more cavities.

The disclosed method comprises:
i) inserting into a wellbore a packer comprising one or more sealing elements; and
ii) activating the one or more sealing elements with an activating means.

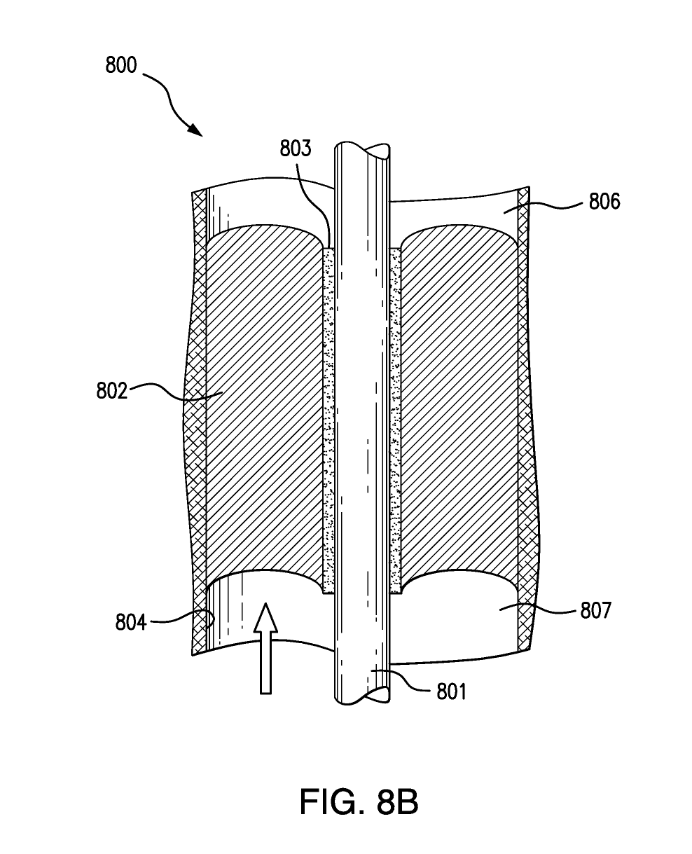

FIGS. 8A and 8B depicts an example of a method for forming a seal in a wellbore and monitoring the status of the seal utilizing a disclosed packer. FIG. 8A depicts the change occurring to packer 800 seated in a wellbore casing having sealing surface 804 before and after activation by an activating means. The packer comprises a conduit or mandrel 801, sensor 803, and sealing element 802. In the figure on the left, the sealing element 802 is in an un-activated state. Because the overall outer diameter of packer 800 is less than the inner diameter of the wellbore insertion of the packer into the wellbore causes annulus 805 to be formed. After activation, sealing element 802 expands and makes contact with sealing surface 804, thereby forming a seal and forming annulus 806 and cavity 807 below the seal. When the sealing element 802 contacts surface 804 a corresponding force is exerted against sensor 803 deposited along conduit wall 801. Sensor 803 is therefore capable of detecting and/or measuring the force applied against sealing surface 804 and conduit 801 when sealing element 802 is activated (FIG. 8A, right side). Sensor 803, which is in electrical communication with the user (not shown) is capable of transmitting a signal indicating the force applied by packer 800 to the wellbore casing.

FIG. 8B depicts the use of a disclosed packer 800 for use in monitoring the seal once drilling operations have begun. An applied force by a liquid, gas or solid acting upward against sealing element 802 will cause a change in resistivity in sensor 803. This change in resistivity caused by the force exerted on sealing element 802 can be measured by the user. A voltage applied between two or more electrodes that are in electrical communication with sensor 803 will pass a current i through the peizoresistive composition that comprises the sensor. This amount of current will be directly related to the resistive properties of the composition. A current, i, at a fixed potential difference, E, passing through sensor 803 as depicted in the left side of FIG. 8A will result in an initial resistance, R, due to the intrinsic resistivity of the piezoresistive composition. Upon activation of the seal by expansion of sealing element 802, as depicted in the right side of FIG. 8A, a force due to the seal pressing against sealing surface 804 and sensor 802 will cause formation of the piezoresistive material. This deformation will result in a change in the intrinsic resistivity of sensor 802. The change in current, Δi, flowing between the electrodes will result in a change in observed resistance, ΔR. Resistance, current and voltage (potential difference) are all related through Ohm's Law. The change in resistivity of the disclosed piezoelectric compositions due to applied forces can be measured by the user as a change in resistance to current flow, change in resulting voltage or as a change in resistance. The user can determine by which parameter the change in resistivity due to compression of the piezoresistive material is monitored.

As shown in FIG. 8B, another force can act upon the seal and therefore provide a further change in resistivity to sensor 803. The user can use this further change in resistivity due to forces present after operations begin to monitor the integrity of the seal or to gather information regarding the applied force.

Disclosed is a method for forming a seal in a wellbore, comprising inserting into a wellbore an apparatus comprising:
a) one or more expandable sealing elements; and
b) at least one sensor containing at least about 0.1% by weight of a piezoresistive composition;
   wherein the apparatus is configured circumferentially along a conduit inserted into the wellbore, and causing the one or more sealing elements to expand thereby forming a seal.

Also disclosed is a method for forming a seal in a wellbore, comprising inserting into a wellbore a sleeve comprising:
a) one or more expandable sealing elements; and
b) at least one sensor containing at least about 0.1% by weight of a piezoresistive composition;

inserting into the wellbore a conduit, and causing the one or more sealing elements to expand thereby forming a seal.

Further disclosed is a method for forming a seal in a wellbore, comprising inserting into a wellbore a sleeve comprising one or more expandable sealing elements, and inserting into the wellbore a conduit having deposited circumferentially thereon at least one sensor containing at least about 0.1% by weight of a piezoresistive composition, and causing the one or more sealing elements to expand thereby forming a seal

In another aspect, the disclosure provides a method for sealing in a subterranean wellbore comprising:
i) providing a disclosed packer, and;
ii) conveying the packer into a wellbore, which may be vertical, horizontal, or deviated, and;
iii) positioning the packer at a desired location within the wellbore, and;
iv) contacting the expandable sealing element comprising the packer with an activating means, and;
v) expanding the expandable sealing element for a period of time, and;
vi) monitoring expanding of the expandable sealing element comprising the packer, via the disclosed sensor, and;
vii) providing feedback to a user indicating the amount of expansion undergone by the sealing element, the amount of force exerted by the sealing element against the conduit sealing surface, or both, and;
viii) determining via said feedback whether an adequate seal has been created in the subterranean wellbore.

The disclosed systems can be operated according to the following example.

### Example 1

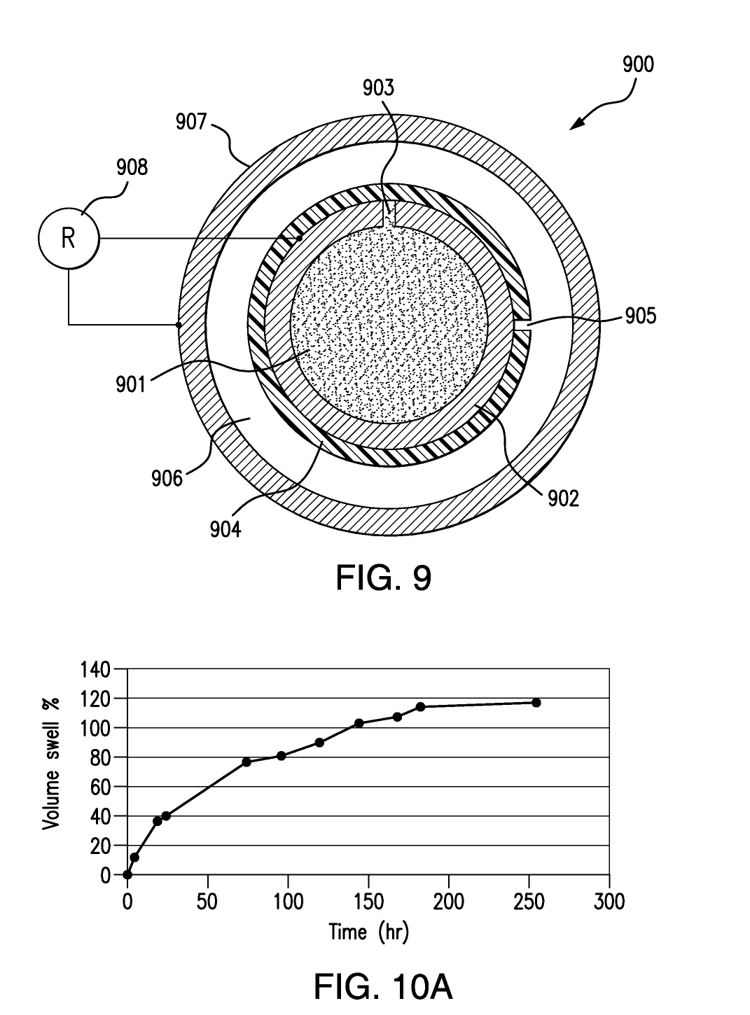

An apparatus 900 was assembled as depicted in FIG. 9. The apparatus comprised a expandable elastomer composition 901; an inner electrode 902, comprising copper and having a gap 903 to allow for expansion; a polymer nanocomposite 904, comprising a piezoresistive composition and having a gap 905 to allow for expansion; and an outer electrode 907, also comprising copper. In this example the inner electrode 902, polymer nanocomposite 904, outer electrode 907, and means for measuring the resistance 908 together comprise the sensor. Prior to activation an annulus 906 existed between polymer nanocomposite 904 and outer electrode 907. Inner electrode 902 and outer electrode 906 had electrical connections affixed thereto and were connected to a means for measuring the electrical resistance 908. The entire apparatus, excepting the means for measuring the resistance 908, was immersed in diesel. A control specimen (not shown) comprising the same composition as 901 was also immersed in the diesel. The control specimen was periodically removed from the diesel, and the percent volume swell was determined

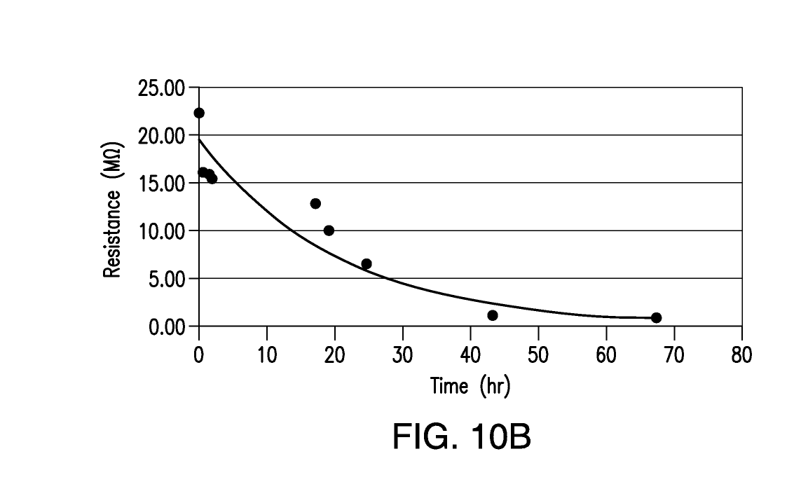

The resulting data are shown in FIG. 10A, which shows the Volume Swell (%) vs Time (hr). As the diameter of the expandable composition 901 increased, the composition came to impinge upon the outer electrode 907, the polymer nanocomposite 904, and the inner electrode 902. The polymer nanocomposite 904 serves as a bridge between the inner electrode 902 and the outer electrode 907, comprising a circuit and further comprising a sensor. As force was applied to the polymer nanocomposite 904 due to impingement of the expandable composition 901, the electrical resistivity of the polymer nanocomposite 904 was altered, thereby reducing the electrical resistance between the inner electrode 902 and the outer electrode 907. The resistance between the inner electrode 902 and the outer electrode 907 was recorded at various time intervals. The resulting data are shown in FIG. 10B, which shows Resistance (megaOhms) vs Time (hr). Therefore, in this example, upon a volume increase of the expandable composition, the sensor is operable to detect or measure a change in electrical properties, thereby verifying swell of the expandable composition.

### Example 2

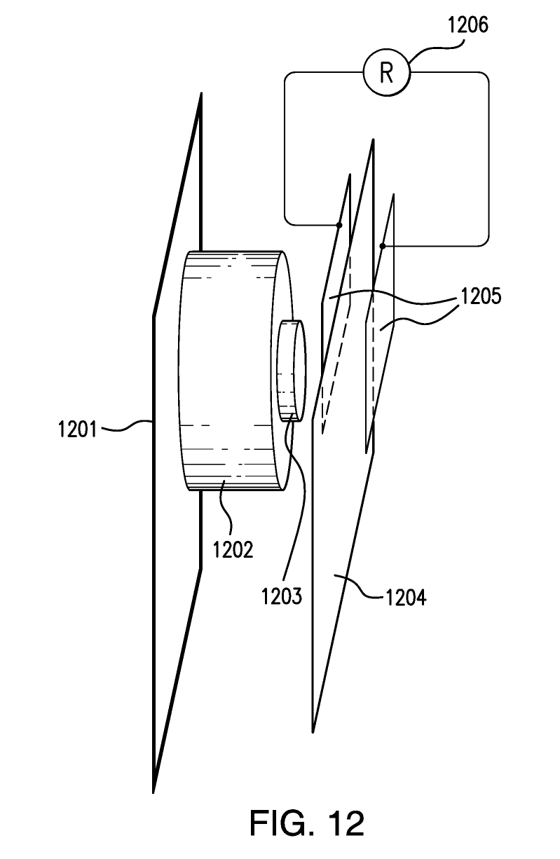

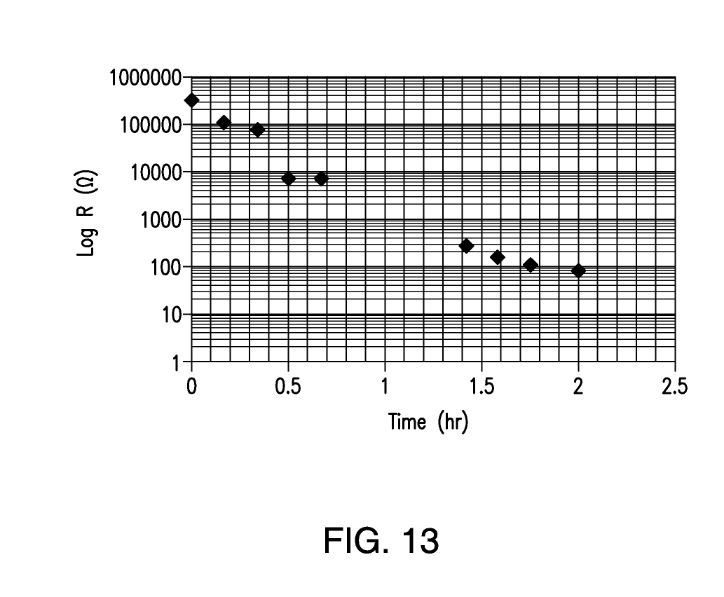

An apparatus 1200 was constructed as depicted in FIG. 12. The apparatus comprises an insulating support 1201 with a solid ring structure 1202 attached thereto, and a expandable elastomer composition 1203 disposed inside the inner diameter of the solid ring structure 1202. The apparatus further comprises a disclosed polymer nanocomposite 1204, disposed between two electrodes 1205. A second insulating support (not shown for figure clarity) was also employed in a mirror image relation to the insulating support 1201 that is shown. The two electrodes had electrical connections affixed thereto, and were connected to a means 1206 for measuring the electrical resistance. The polymer nanocomposite 1204, the two electrodes 1205, and the means for measuring the resistance 1206 together comprise the sensor. The entire apparatus 1200, excepting the means for measuring the resistance 1206, was immersed in diesel and placed in an oven with temperature of approximately 100° C. for a period of approximately two hours. During this time period, the expandable composition 1203 increased in volume and impinged upon the polymer nanocomposite 1204 and electrodes 1205. The measured resistance decreased by more than three orders of magnitude, as shown in FIG. 13. The total volume increase in the expandable composition 1207 was approximately 65% over this time period. Therefore, in this example, upon a volume increase of the expandable composition, the sensor is capable of detecting or measuring a change in electrical properties, thereby verifying expansion of the expandable composition.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. An apparatus for forming a seal in a wellbore, comprising:
a) one or more expandable sealing elements; and
b) at least one sensor;
wherein at least about 0.1% by weight of the sensor comprises a piezoresistive composition.

2. The apparatus according to claim 1, further comprising a means for electrical communication between the sensor and a user.

3. The apparatus according to claim 1, wherein the one or more sealing elements comprise one or more elastomeric materials.

4. The apparatus according to claim 3, wherein the elastomeric material is chosen from ethylene-propylene-copolymer rubber, ethylene propylene diene monomer rubber, ethylene-propylene-diene terpolymer rubber, butyl rubber, natural rubber, halogenated butyl rubber, styrene butadiene rubber, ethylene vinyl acetate rubber, nitrile butadiene rubber, hydrogenated nitrile butadiene rubber, highly saturated nitrile rubber, chloroprene rubber, polyisoprene, polyisobutylene, polybutadiene, polysiloxane, poly-dimethylsiloxane, and thereof.

5. The apparatus according to claim 1, wherein the sealing element comprises one or more adjunct ingredients chosen from fillers, plasticizers, processing aids, anti-oxidants, curatives, and mixtures thereof.

6. The apparatus according to claim 5, wherein the adjunct ingredient is a nanomaterial chosen from carbon nanotubes, carbon nanosprings, carbon nanocoils, graphene, graphene-oxide, chemically converted graphene, exfoliated graphite, intercalated graphite, grafoil, carbon nanoonions, vapor grown carbon fibers, pitch based carbon fibers, polyacrylonitrile (PAN) based carbon fibers, and mixtures thereof.

7. The apparatus according to claim 1, wherein the sealing element comprises:
a) from about 50% to about 99.99% by weight of one or more polymers; and
b) from about 0.01% to about 50% by weight of one or more nanomaterials.

8. The apparatus according to claim 1, wherein the at least one sensor comprises one or more polymers chosen from thermoplastic, elastomeric, thermoplastic elastomeric, or thermoset polymers.

9. The apparatus according to claim 8, wherein the polymer comprises one or more monomers chosen from ethylene, propylene, butadiene, isoprene, acrylonitrile, styrene, isobutylene, and mixtures thereof, wherein the monomers can further comprise one or halogens.

10. The apparatus according to claim 8, wherein the polymer comprises one or more polymers chosen from natural rubber, polyisoprene, butyl rubber, halogenated versions thereof, polybutadiene, styrene-butadiene rubber, nitrile butadiene and hydrogenated nitrile butadiene, polychloroprene, ethylene propylene rubbers, silicone rubbers, polydimethylsiloxane, ethylene vinyl acetate, polymethylmethacrylate, fluroroelastomers such as fluorinated ethylene propylene monomer rubber, perfluroelastomers, and mixtures thereof.

11. The apparatus according to claim 8, wherein the sensor further comprises one or more conductive elements.

12. The apparatus according to claim 11, wherein the one or more conductive elements have at least one dimension less than about 100 nanometers.

13. The apparatus according to claim 11, wherein the one or more conductive elements are chosen from carbon nanotubes, carbon nanosprings, carbon black, carbon nanocoils, graphene, graphene-oxide, exfoliated graphite, intercalated graphite, grafoil, carbon nanoonions, vapor grown carbon fibers, pitch based carbon fibers, or polyacrylonitrile (PAN) based carbon fibers.

14. The apparatus according to claim 13, wherein the one or more conductive elements is carbon black.

15. The apparatus according to claim 13, wherein one or more of the conductive elements is a functionalized carbonaceous material.

16. A wellbore packer, comprising one or more apparatuses according to claim 1.

17. An apparatus for forming a seal in a wellbore, comprising:
A) a conduit having deposed circumferentially along the outside thereof:
i) one or more sensors; and
ii) one or more sealing elements; and
B) a means for electrical communication between the one or more sensors and a user.

18. The apparatus according to claim 17, wherein at least one sealing element can be selectively activated.

19. An apparatus for forming a seal in a wellbore, comprising:
A) a sleeve for insertion into a wellbore along the inside surface of the wellbore wherein the outside surface of the sleeve is slidably attached to the inside surface of the wellbore, the sleeve having deposited along the inside surface:
i) one or more sensors; and
ii) one or more sealing elements; and
B) a means for electrical communication between the one or more sensors and a user.

21. An apparatus for forming a seal in a wellbore, comprising:
A) a circular sleeve for insertion into a wellbore along the inside surface of the wellbore wherein the outside surface of the sleeve is slidably attached to the inside surface of the wellbore, the sleeve having deposited along the inside surface one or more sealing elements;
B) a conduit having deposed circumferentially along the outside circumference thereof one or more sensors; and
C) a means for electrical communication between the one or more sensors and a user.

22. An apparatus for forming a seal in a wellbore, comprising:
A) a circular sleeve for insertion into a wellbore along the inside surface of the wellbore wherein the outside surface of the sleeve is slidably attached to the inside surface of the wellbore, the sleeve having deposited along the inside surface one or more sensors;
B) a conduit having deposed circumferentially along the outside circumference thereof one or more sealing elements; and
C) a means for electrical communication between the one or more sensors and a user.

23. A method for forming a seal in a wellbore, comprising inserting into a wellbore an apparatus comprising:
a) one or more expandable sealing elements; and
b) at least one sensor containing at least about 0.1% by weight of a piezoresistive composition;
wherein the apparatus is configured circumferentially along a conduit inserted into the wellbore, and causing the one or more sealing elements to expand thereby forming a seal.

24. A method for forming a seal in a wellbore, comprising inserting into a wellbore a sleeve comprising:
a) one or more expandable sealing elements; and
b) at least one sensor containing at least about 0.1% by weight of a piezoresistive composition;
inserting into the wellbore a conduit, and causing the one or more sealing elements to expand thereby forming a seal.

25. A method for forming a seal in a wellbore, comprising inserting into a wellbore a sleeve comprising one or more expandable sealing elements, and inserting into the wellbore a conduit having deposited circumferentially thereon at least one sensor containing at least about 0.1% by weight of a piezoresistive composition, and causing the one or more sealing elements to expand thereby forming a seal.
